(19) United States
(12) Patent Application Publication
(10) Pub. No.: US 2025/0069323 A1
(43) Pub. Date: Feb. 27, 2025

(54) SYSTEMS AND METHODS FOR VIRTUAL REALITY IMMERSIVE CALLING

(71) Applicant: CANON U.S.A., INC., MELVILLE, NY (US)

(72) Inventors: Jason Mack Williams, Huntington, CA (US); Ryuhei Konno, Plainview, NY (US); Jonathan Forr Lorentz, Costa Mesa, CA (US); Bradley Scott Denney, Irvine, CA (US); Xiwu Cao, Irvine, CA (US); Peng Sun, Irvine, CA (US); Quentin Dietz, Irvine, CA (US); Jeanette Yang Paek, Los Alamitos, CA (US)

(21) Appl. No.: 18/724,538

(22) PCT Filed: Dec. 29, 2022
(86) PCT No.: PCT/US2022/082590

§ 371 Date: Jun. 26, 2024

Related U.S. Application Data
(60) Provisional application No. 63/295,510, filed on Dec. 30, 2021.

(51) Int. Cl. G06T 15/50; G06V 10/44; H04N 1/60

(52) U.S. Cl. CPC G06T 15/506; G06V 10/44; H04N 1/6002

(57) ABSTRACT

An information processing apparatus and method for relighting captured images in a virtual reality environment is provided. Righting processing performed by the apparatus includes acquiring an input image, acquiring a target image, determining at least one shared reference region for the acquired input image and at least one shared reference region for the acquired target image, determining a transform matrix based on the color space of the shared region, applying the transform matrix to at least a portion of the acquired input image, outputting the transformed portion of the acquired input image, and displaying the outputted transformed portion of the acquired input image.

### CROSS-REFERENCE TO RELATED APPLICATIONS

This application claims the benefit of priority from U.S. Provisional Patent Application Ser. No. 63/295,510, filed on Dec. 30, 2021, the entirety of which is incorporated herein by reference.

### BACKGROUND

### Field

The present invention relates virtual reality, and more specifically to methods and systems for immersive virtual reality communication.

### Description of Related Art

Given the big progresses that have been recently made in virtual or mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

However, the images of different users to be used in a virtual environment are often taken at different locations and angles with different devices. These inconsistent user positions/orientations and lighting conditions drastically affect participants from having a fully immersive virtual conference experiences.

### SUMMARY

According to an embodiment, an information processing apparatus and method for relighting captured images in a virtual reality environment is provided. Righting processing performed by the apparatus includes acquiring an input image, acquiring a target image, determining at least one shared reference region for the acquired input image and at least one shared reference region for the acquired target image, determining a transform matrix based on the color space of the shared region, applying the transform matrix to at least a portion of the acquired input image, outputting the transformed portion of the acquired input image, and displaying the outputted transformed portion of the acquired input image.

In certain embodiments, the determination of at least one shared reference region for the acquired input image and at least one shared reference region for the acquired target image is based on respective extracted feature points on acquired input image and acquired target image. In other embodiments, relighting processing includes converting the device dependent color space data on at least one shared reference region for the acquired input image and the at least one shared reference region for the acquired target image to device independent color space data. This may also include converting the transformed portion of the acquired input image from device independent color space data back to device dependent color space data.

In further embodiments, selection of the input image and selection of the target image to be acquired is performed via a manual operation. In others, it includes automatically determining the selection of the input image and selection of the target image to be acquired based on a feature point detection operation. Further embodiments of the relighting processing includes Determining the shared regions by extracting at least one feature point for the acquired input image and at least one feature point for the acquired target image.

In another embodiment, an information processing apparatus and method for relighting captured images in a virtual reality environment is provided. Righting processing performed by the apparatus includes acquiring an input image; acquiring a target image; determining at least one shared reference region for the acquired input image and at least one shared reference region for the acquired target image; calculating a covariance matrix of the at least one shared reference region for the acquired input image and the at least one shared reference region for the acquired target image from device dependent color space data associated with the respective at least one shared reference regions; determining a transform matrix based on the calculated covariance matrices; applying the transform matrix to at least a portion of the acquired input image; outputting the transformed portion of the acquired input image; and displaying the outputted transformed portion of the acquired input image.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is a diagram illustrating a virtual reality capture and display system.

FIG. 2 is a diagram illustrating an embodiment of the system with two users in two respective user environments according to a first embodiment.

FIG. 3 is a diagram illustrating an example of a virtual reality environment as rendered to a user.

FIG. 4 is a diagram illustrating an example of a second virtual perspective 400 of the second user 270 of FIG. 2.

FIG. 5A and FIG. 5B are diagrams illustrating examples of immersive calls in a virtual environment in terms of the users starting positions.

FIG. 6 is a flowchart illustrating a call initiation flow which puts the first and second user of the system in the proper position to carry out the desired call characteristics.

FIG. 7 is a diagram illustrating an example of directing a user to the desired position.

FIG. 8 is a diagram illustrating an example of detecting a person via the capture device and estimating a skeleton as three dimensional points.

FIGS. 9A-9E illustrates exemplary user interface for user recommended actions of move right, move left, back up, move forward, turn left, and turn right respectively.

FIG. 10 is an overall flow of an immersive virtual call according to one embodiment of the present invention.

FIG. 11 is a diagram illustrating an example of a system for virtual reality immersive calling system.

FIG. 12A-D illustrate user workflows for aligning a sitting or standing position in an immersive calling system.

FIGS. 13A-E illustrates various embodiments for boundaries setting in an immersive calling system.

FIGS. 14, FIG. 15, FIG. 16, FIG. 17, and FIG. 18 illustrate various scenarios for user interaction in the immersive calling system.

FIG. 19 is a diagram illustrating an example of transforming images to be displayed in a game engine in the GPU.

FIG. 20 is a diagram showing a wireless version of FIG. 19.

FIG. 21 is a diagram showing a version FIG. 19 using a stereoscopic camera for image capture.

FIG. 22 illustrates an exemplary workflow for region-based object relighting using Lab color space.

FIG. 23 illustrates a region-based method for the relighting of an object or an environment using Lab color space using a human face as an example.,

FIG. 24 illustrates a user wearing a VR headset.

FIGS. 25A and 25B illustrate an example where 468 face feature points extracted from both input and target image.

FIG. 26 illustrates a region-based method for the relighting of an object or an environment using a covariance matrix of RGB channel.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

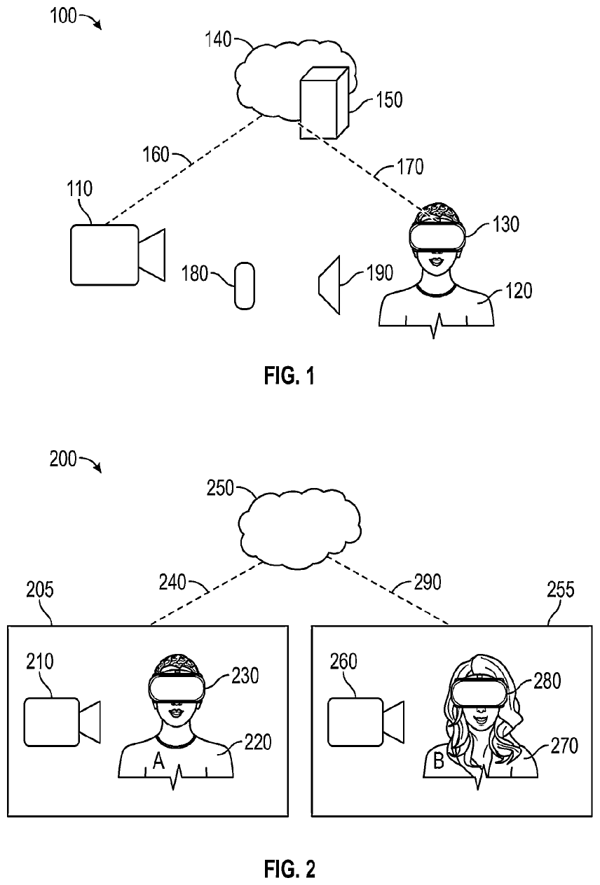

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit. FIG. 1 shows a virtual reality capture and display system 100. The virtual reality capture system comprises a capture device 110. The capture device may be a camera with sensor and optics designed to capture 2D RGB images or video, for example. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g. a lidar system, or a point-cloud based depth sensor). The capture device may be connected via a network 160 to a local or remote (e.g. cloud based) system 150 and 140 respectively, hereafter referred to as the server 140. The capture device 110 is configured to communicate via the network connect 160 to the server 140 such that the capture device transmits a sequences of images (e.g. a video stream) to the server 140 for further processing. Also, in FIG. 1, a user of the system 120 is shown. In the example embodiment the user is wearing a Virtual Reality (VR) device 130 configured to transmit stereo video to the left and right eye of the user 120. As an example, the VR device may be a headset worn by the user. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

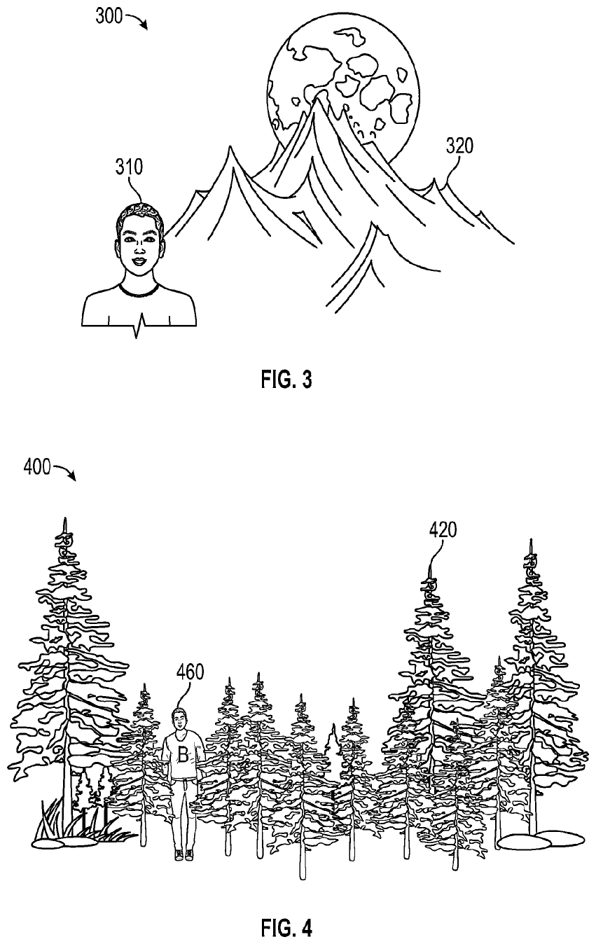

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 290 to a server 250. In some instances only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

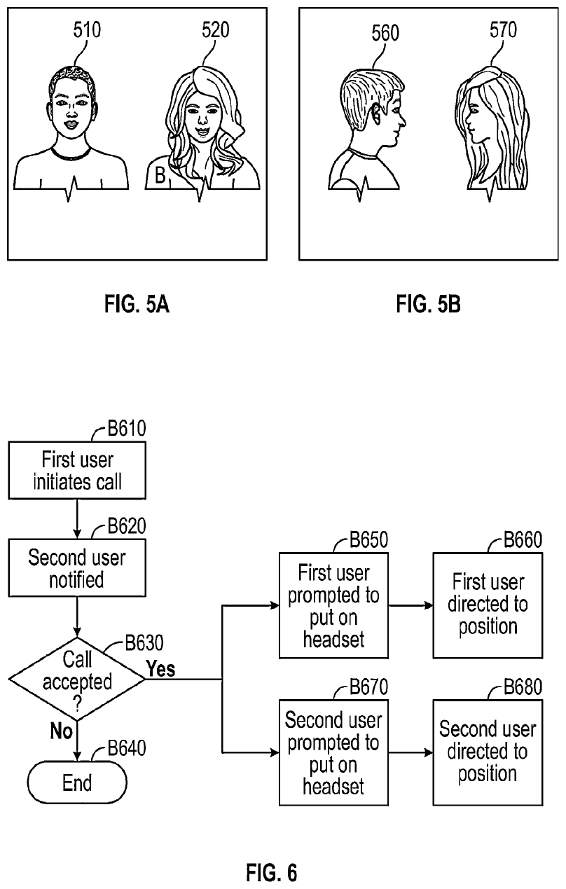

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300. In the example of FIG. 3, the user rendition 310 of user 270 of FIG. 2, shows the user without the respective VR device 280. Some embodiments show the user with the VR device 280. In other embodiments the user 270 does not use a wearable VR device 280. Furthermore, in some embodiments the captured images of user 270 capture a wearable VR device, but the processing of the user images remove the wearable VR device and replace it with the likeness of the users face.

Additionally the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

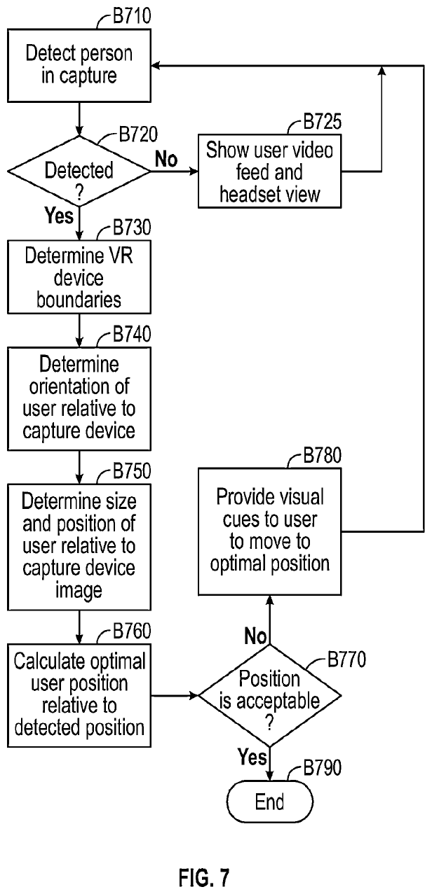

FIG. 4 shows a second virtual perspective 400 of the second user 270 of FIG. 2. The second virtual perspective 400 will be shown in the virtual device 230 of first user 220 of FIG. 2. The second virtual perspective will include virtual content 420 which may be based on the same virtual content 320 of FIG. 3 but from the perspective of the virtual rendition of the character 310 of FIG. 3 representing the viewpoint of user 220 of FIG. 2. The second virtual perspective may also include a virtual rendition of the second user 270 of FIG. 2.

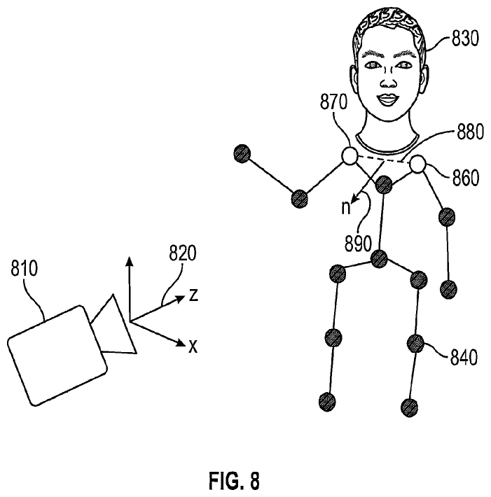

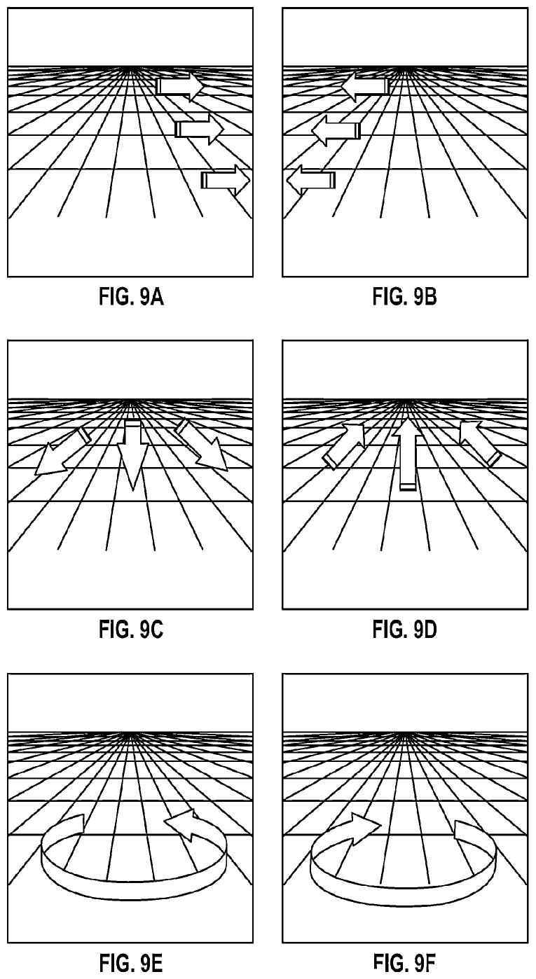

FIG. 6 illustrates a call initiation flow which puts the first and second user of the system in the proper position to carry out the desired call characteristics, such as the two examples shown in FIG. 5A and in FIG. 5B. The flow starts in block B610 where a first user initiates an immersive call to a second user. The call may be initiated via an application on the users VR device, or through another intermediary device such as the users local computer, cell phone, voice assistant (such as Alexa, Google Assistant, or Siri for example). The call initiation executes instructions to notify the server such as the one shown in 140 of FIG. 1 or 250 of FIG. 2 that the user intends to make an immersive call with the second user. The first user may be chosen via the app, from a list of contacts for example known to have immersive calling capabilities. The server responds to the call initiation by notifying in block B620, in turn, the second user that the first user is attempting to initiate an immersive call with the second user. An application on the second users local device such as the user's VR device, cellphone, computer, or voice assistant as just a few examples, provides the final notification to the second user giving the second user the opportunity to accept the call. In block B630 if the call is not accepted either by choice of the second user or via a timeout period waiting for a response, the flow proceeds to block B640 where the call is rejected. In this call the first user may be notified that the second user did not accept the call either actively or passively. Other embodiments include the case where the second user is either detected to be in a do not disturb mode, or on another active call. In these cases the call may also not be accepted. If in block B630 the call is accepted, flow then proceeds to block B650 for the first user and to block B670 for the second user. In blocks B650 and B670 the respective users are notified that they should don their respective VR devices. At this time the system initiates a video stream from the first and second users' respective image capture devices. The video streams are processed via the server to detect the presence of the first and second users and to determine the users' placement in the captured image. Blocks B660 and B680 then provide cues via the VR device application for the first and second users respectively to move into the proper position for an effective immersive call.

Thus the collective effect of the system is to present a virtual world that includes 300 of FIG. 3 and 400 of FIG. 4 that presents the illusion of the meeting of the first user and the second user in a shared virtual environment.

FIG. 5A and FIG. 5B show two examples of immersive calls in a virtual environment in terms of the users starting positions. For example, in some instances shown in FIG. 5A, the users' renditions 510 and 520 are placed side by side. For example, if both users intend on viewing VR content together, it may be preferable to be placed side by side. For example, this may be the case when viewing of a live event or a video or other content. In other instances as shown in FIG. 5B the renditions of the first 560 and second user 570 (representing users 220 and 270 respectively of FIG. 2) are placed into a virtual environment such that they are face-to-face. For example, if the intent of the immersive experience is for the two users to meet, they may want to enter the environment face-to-face.

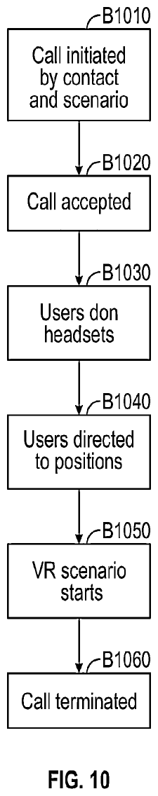

FIG. 7 describes an exemplary embodiment for directing a user to the desired position. This flow can be used for both the first and second user. The flow begins in block B710 where the image capture device, providing video frames to the server is analyzed to determine whether there is a person in the capture image. One such embodiment performs face detection to determine if there is a face in the image. Other embodiments use a full person detector. Such detectors may detect the presence of a person and may estimate a “body skeleton” which may provide some estimates of the detected person's pose.

Block B720 determines whether a person was detected. Some embodiments may contain detectors that can detect more than one person, however, for the purposes of the immersive call, only one person is of interest. In the case of the detection of multiple people some embodiments warn the user there are multiple detections and ask the user to direct others outside of the view of the camera. In other embodiments the most centrally detected person is used, yet other embodiments may select the largest detected person. It shall be understood that other detection techniques may also be used. If block B720 determines that no person was detected flow moves to block B725 where, in some embodiments, the user is shown the streaming video of the camera in the VR device headset alongside of the captured video taken from the VR device headset if available. In this fashion, the user can both see their camera from their viewpoint as well as the scene being captured from the capture device viewpoint. These images may be shown side by side or as picture in picture for example. Flow then moves back to block B710 where the detection is repeated. If block B720 determines there is a person detected then flow moves to block B730.

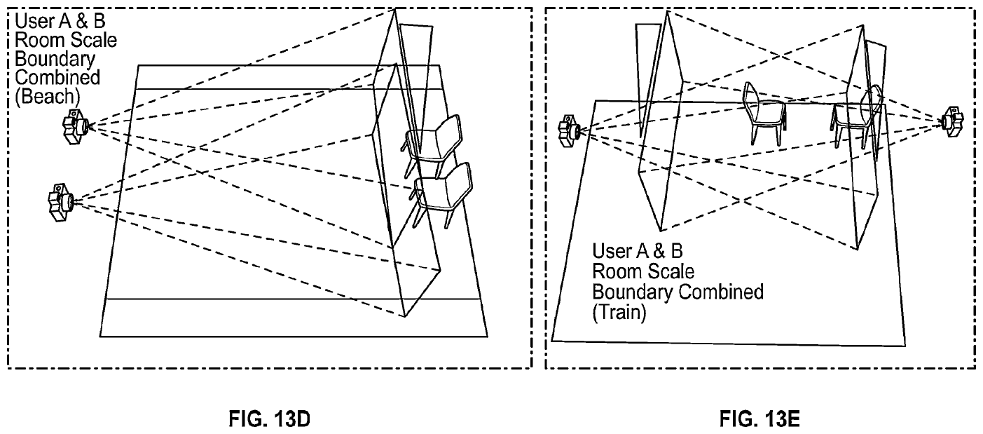

In block B730 the boundaries of the VR device are obtained (if available) relative to the current user position. Some VR devices provide guardian boundaries and are capable of detecting when a user moves near or outside of their virtual boundaries to prevent them from colliding with other real world objects while they are wearing the headset and immersed in a virtual world. VR boundaries is explained in more details, for example, in connection with FIGS. 13A-13E. Flow then moves to block B740.

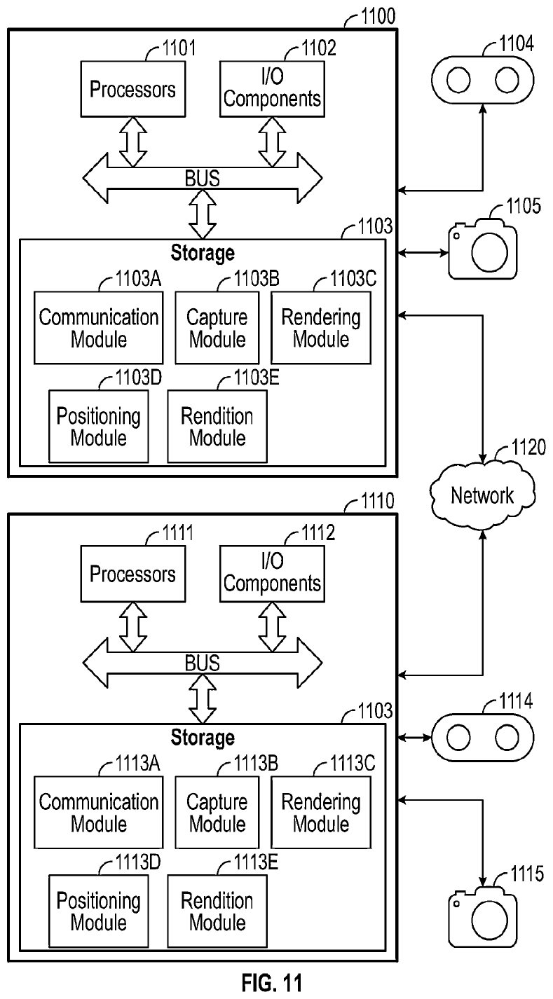

Block B740 determines the orientation of the user relative to the capture device. For example, one embodiment as shown in FIG. 8, detects a person 830 via the capture device 810 and estimates a skeleton 840 as 3-D points. The orientation of the user relative to the capture device may be the orientation of the user's shoulders relative to the capture device. For example, if a left and right shoulder point 860 and 870 respectively are estimated in 3D, a unit vector n 890 may be determined such that it emanates from the midpoint of the two shoulder points, is orthogonal to the line connecting the two shoulder points 880, and is parallel to the capture device's horizontal x and depth z (optical) axes 820. In this embodiment the dot product of the vector n 890 with the negative capture device axis-z will generate the cosine of the user orientation relative to the capture device. If n and z are both unit vectors then a dot product near 1 indicates the user is in a position such that their shoulders are facing the camera, which is ideal for a capture for face-to-face scenarios such as shown in FIG. 5B. However, if the dot product is near zero, it indicates that the user is facing to the side which is ideal for the scenario shown in FIG. 5A. Furthermore, in scenario of side by side, one user should be captured from their right side and placed to the left of side of the other user who should be captured from their left side. To determine whether the user is facing so that their left or right side is captured, the depth of the two shoulder points 860 and 870 can be compared to determine which shoulder is closer to the capture device in depth. In some embodiments other joints are used as reference joints in a similar fashion, such as the hips or the eyes.

Additionally the detected skeleton in FIG. 8 may also be used to determine the size of detected person based on estimated joint lengths. Through calibration, joint lengths may be used to estimate the upright size of the person, even if they aren't completely upright. This allows the detection system to determine the physical height of the user bounding box in cases where the height of the user is approximately know a priori. Other reference lengths can also be utilized to estimate user height; the size of the headset for example, is known for a given device and varies little from device to device. Therefore, user height can be estimated based on reference lengths such as headset size when they co-appear in the captured frame. Some embodiments, ask the user for their height when they create a contact profile so that they may be properly scaled when rendered in the virtual environment.

In some embodiments the virtual environments are real indoor/outdoor environments captured via 3-D scanning and photogrammetry methods for example. Therefore it corresponds to a real 3D physical world of know dimensions and sizes and a virtual camera through which the world is rendered to the user to the system may position the person's rendition in different locations in the environment independent of the position of the virtual camera in the environment. To yield realistic interactive experience therefore requires the program to correctly project the real camera-captured view of the person to the desired position in the environment with a desired orientation. This can be done by creating a person-centric coordinate frame based on skeleton joints and the system may obtain the reprojection matrix.

Some embodiments show the user's rendition on a 2-D projection screen (planar or curved) rendered in the 3-D virtual environment (sometimes rendered stereoscopically or via a light field display device). Note that in these cases, if the view angle is very different from the capture angle, then the projected person will no longer appear realistic; in the extreme case when the projection screen is parallel to the optic axis of the virtual camera, the user will simply see a line that represents the projection screen. However, because the flexibility of the visual system, the second user will by and large see the projected person as a 3D person for moderate range of differences between the capture angle in the physical world and the virtual view angle in the virtual world. This means that both users during the communication are able to undergo a limited range of movement without breaking their opponent's 3D percept. This range can be quantified and this information used to guide the design of different embodiments for positioning the users with respect to their respective capture devices.

In some embodiments the user's rendition is presented as a 3-D mesh in lieu of a planar projection. Such embodiments may allow greater flexibility in range of movements of the users and may further influence the positioning objective.

Returning to FIG. 7, once block B740 determines the orientation of the user relative to the capture device, flow continues to block B750.

Block B750 determines the size and position of the user in the capture device frame. Some embodiments prefer to capture the full body of the user, and will determine whether the full body is visible. Additionally the estimated bounding box of the user may be determined in some embodiments such that the center, height, and width of the box in the capture frame are determined. Flow then proceeds to block B760.

In block B760 the optimal position is determined. In this step, first the estimated orientation of the user relative to the capture device is compared to the desired orientation given the desired scenario. Second, the bounding box of the user is compared to an ideal bounding box of the user. For example some embodiments determine that the estimated user bounding box should not extend beyond the capture frame so that the whole body can be captured, and that there are sufficient margins above and below the top and bottom of the box to allow the user to move and not risk moving out of the capture device area. Third, the position of the user should be determined (e.g. the center of the bounding box) and should be compared to the center of the capture area to optimize the movement margin. Also some embodiments inspect the VR boundaries to ensure that the current placement of the user relative to the VR boundaries provides sufficient margins for movement.

Some embodiments include a position score S that is based at least in part on one or more of the following scores: a directional pose score p, a positional score x, a size score s, and a boundary score b.

The pose score may be based on the dot product of the vector n 890, with the vector z 820 of FIG. 8. Additionally the z-position of the detected left and right shoulder, 860 and 870 respectively are used to convert the pose angle θ.

$$θ = \{ \begin{matrix}{cos}^{- 1} ( - n \cdot z ) , & left shoulder closer to capture \\ - {cos}^{- 1} ( - n \cdot z ) , & right shoulder closer to capture\end{matrix}$$

Thus one pose score may be expressed as

$$p = ‖ θ - {θ}_{desired} ‖$$

Where the above norm, must take into account the cyclic nature of θ. For example, one embodiment defines ∥θ−θ_{desired}∥ as

$$p = ‖ θ - {θ}_{desired} ‖ = {[ sin ( θ ) - sin ( {θ}_{d e s i r e d} ) ]}^{2} + {[ cos ( θ ) - cos ( {θ}_{d e s i r e d} ) ]}^{2}$$

The positional score may measure the position of a detected person in the capture device frame. An example embodiment of the positional score is based at least in part on the captured person bounding box center c and the c capture frame width W and height H:

$$x = {( {c}_{x} - \frac{W}{2} )}^{2} + {( {c}_{x} - \frac{H}{2} )}^{2}$$

The boundary score b provides a score for the user's position within the VR device boundaries. In this case if the users position (u, v) on the ground plane is given such that position (0,0) provides the location in the ground plane such that a circle of maximum radius can be constructed that is circumscribed by defined boundary. In this embodiment, the boundary score may be given as

$$b = {\vert u \vert}^{2} + {\vert v \vert}^{2}$$

The total score for assessing the user pose and position can then be given as the objective J:

$$J = {λ}_{p} f ( p ; {Γ}_{p} ) + {λ}_{x} f ( x ; {Γ}_{x} ) + {λ}_{s} f ( s ; {Γ}_{s} ) + {λ}_{b} f ( b ; {Γ}_{b} )$$

where λₚ, λₓ, λₛ, and λ_{b} are weighting factors providing relative weights for each score, and f is a score shaping function with parameters Γ that describes a monotonic shaping function of the score. As one example

f(b;Γ_{b})

where Γ_{b} is a positive number.

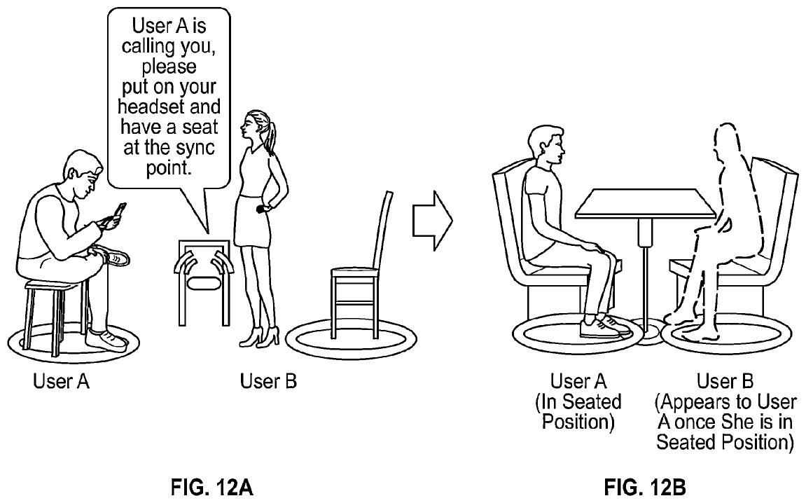

The flow then moves to block B770 where it is determined whether to position and pose of the user is acceptable. If not flow continues to block B780 where visual cues are provided to the user to assist them to move to a better position. An example UI is shown in FIG. 9A, FIG. 9B, FIG. 9C, FIG. 9D, FIG. 9E, and FIG. 9F for user recommended actions of move right, move left, back up, move forward, turn left, and turn right respectively. Combinations of these may also be possible to indicate a flow for the user.

Returning to FIG. 7, once the user is provided visual cues, flow proceeds back to block B710 where the process repeats. When block B770 finally determines that the orientation and position are acceptable, the flow moves to block B790 where the process ends. In some embodiments the process continues for the duration of the immersive call and if block B770 determines the position is acceptable the flow returns to block B710 skipping block B780 which provides positioning cues.

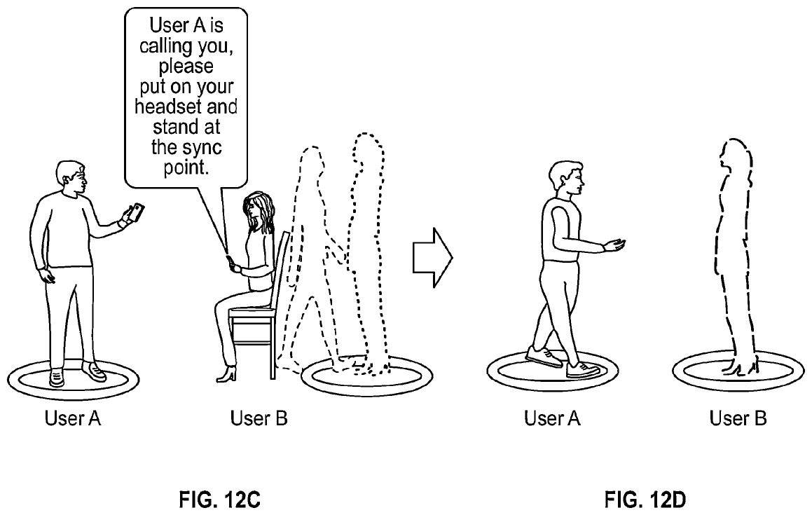

The overall flow of an immersive call embodiment is shown in FIG. 10. Flow starts in block B1010 where the call is initiated by the first user based on a selected contact as the second user and a selected VR scenario. Flow then proceeds to block B1020 where the second user either accepts the call, or the call is not accepted in which case the flow ends. If the call is accepted flow continues to block B1030 where the first and second users are prompted to don their VR devices (headsets). Flow then proceeds to block B1040 where the users are individually directed to their appropriate positions and orientations based on their position relative to their respective capture devices and the selected scenario. Once the users are in an acceptable position, flow continues to B1050 where the VR scenario begins. During the VR scenario the users will have the option to terminate the call at any time. In block B1060, the call is terminated and the flow is terminated.

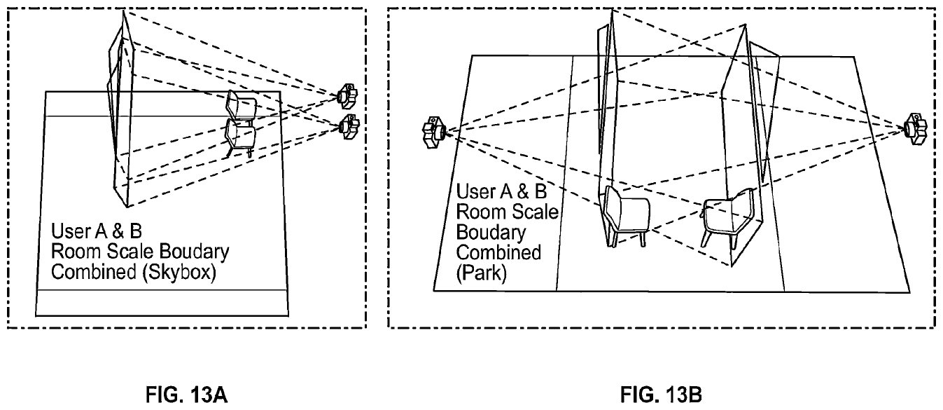

FIG. 11 illustrates an example embodiment of a system for virtual reality immersive calling system. The system 11 includes two user environment systems 1100 and 1110, which are specially-configured computing devices; two respective virtual reality devices 1104 and 1114, and two respective image capture devices 1105 and 1115. In this embodiment, the two user environment systems 1100 and 1110 communicate via one or more networks 1120, which may include a wired network, a wireless network, a Local Area Network (LAN), a Wide Area Network (WAN), a Metropolitan Area Network (MAN), and a Personal Area Network (PAN). Also, in some embodiments the devices communicate via other wired or wireless channels.

The two user environment systems 1100 and 1110 include one or more respective processors 1101 and 1111, one or more respective I/O components 1102 and 1112, and respective storage 1103 and 1113. Also, the hardware components of the two user environment systems 1100 and 1110 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 1101 and 1111 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 1102 and 1112 include communication components (e.g., a graphics card, a network-interface controller) that communicate with the respective virtual reality devices 1104 and 1114, the respective capture devices 1105 and 1115, the network 1120, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 1103 and 1113 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 1103 and 1113, which may include both ROM and RAM, can store computer-readable data or computer-executable instructions. he two user environment systems 1100 and 1110 also include respective communication modules 1103A and 1113A, respective capture modules 1103B and 1113B, respective rendering module 1103C and 1113C, respective positioning module 1103D and 1113D, and respective user rendition modules 1103E and 1113E. A module includes logic, computer-readable data, or computer-executable instructions. In the embodiment shown in FIG. 11, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 1103 and 1113. Also, in some embodiments, the two user environment systems 1100 and 1110 includes additional or fewer modules, the modules are combined into fewer modules, or the modules are divided into more modules. One environment system may be similar to the other or may be different in terms of the inclusion or organization of the modules.

The respective capture modules 1103B and 1113B include operations programed to carry out image capture as shown in 110 of FIGS. 1, 210 and 260 of FIG. 2, 810 of FIG. 8, and used in block B710 of FIGS. 7 and B1040 of FIG. 10. The respective rendering module 1103C and 1113C contain operations programed to carry out the functionality described in blocks B660 and B680 of FIG. 6, blocks B780 of FIG. 7, block B1050 of FIG. 10 and examples of FIG. 9A-9F, for example. The respective positioning module 1103D and 1113D contain operations programmed to carry out the process described by FIGS. 5A and 5B, B660 and B680 of FIG. 6, FIG. 7, FIG. 8, and FIG. 9. The respective user rendition modules 1103E and 1113E contains operations programmed to carry out user rendering as illustrated in FIG. 3, FIG. 4, FIG. 5A and FIG. 5B.

In another embodiment, user environment systems 1100 and 1110 are incorporated in VR devices 1104 and 1114 respectively. In some embodiments the modules are stored and executed on an intermediate system such as a cloud server.

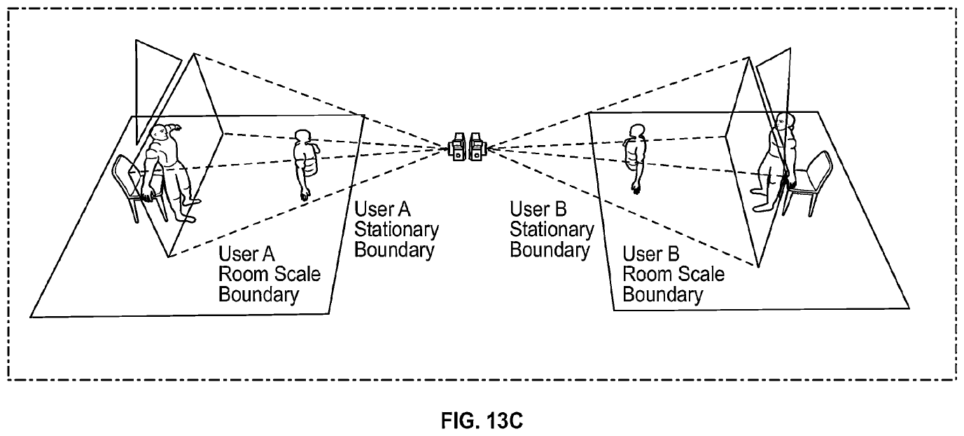

FIGS. 12A-D illustrate user workflows for aligning a sitting or standing position between user A and user B as described in Blocks B660 and B680 of FIG. 6. In FIG. 12A, user A, who is in a seated position, calls user B and the system prompts user B, who is in a standing position, to put on a headset and have a seat at the designated area. As a result, FIG. 12B illustrates a virtual meeting is conducted in a seated position. In another scenario described in FIG. 12C, user A, who is in a standing position, calls user B. The system prompts user B, who is in a seated position, to put on a headset and have a seat at the designated area. As a result, FIG. 12D illustrates a situation where a virtual meeting is conducted in a standing position.

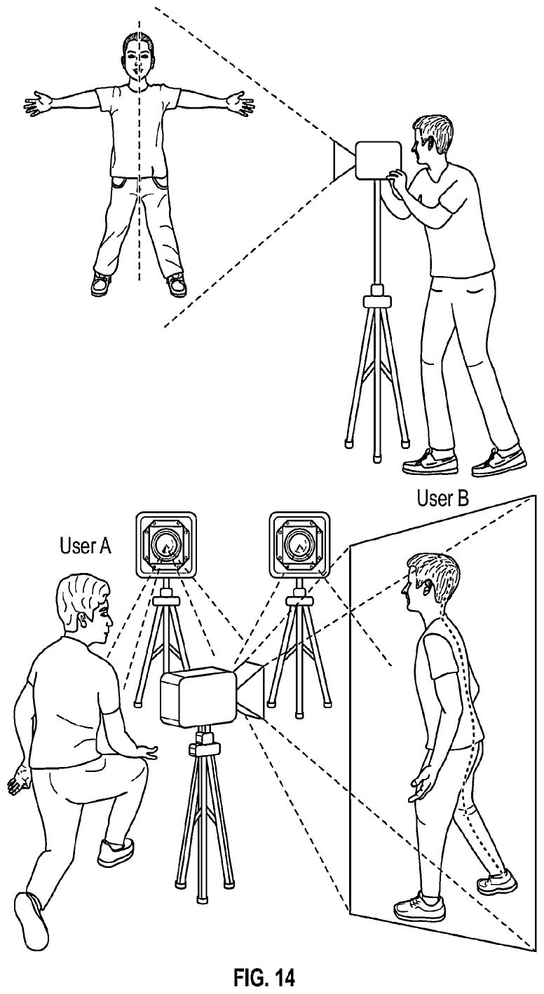

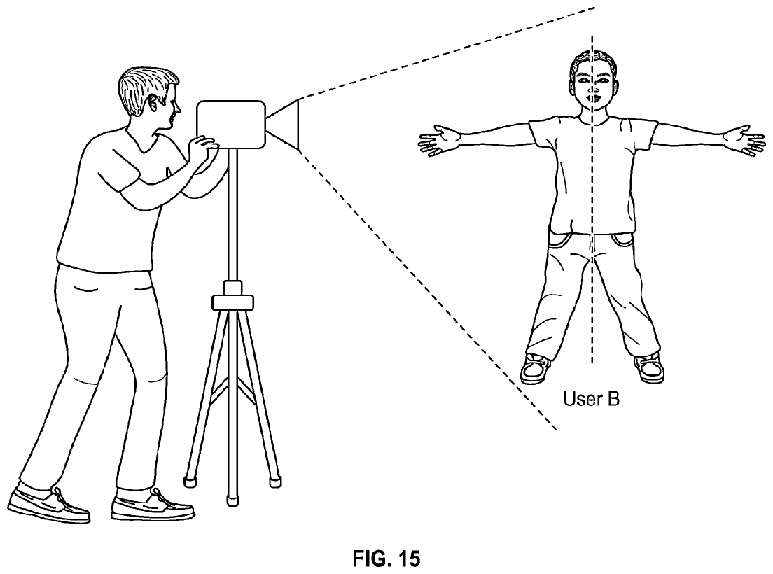

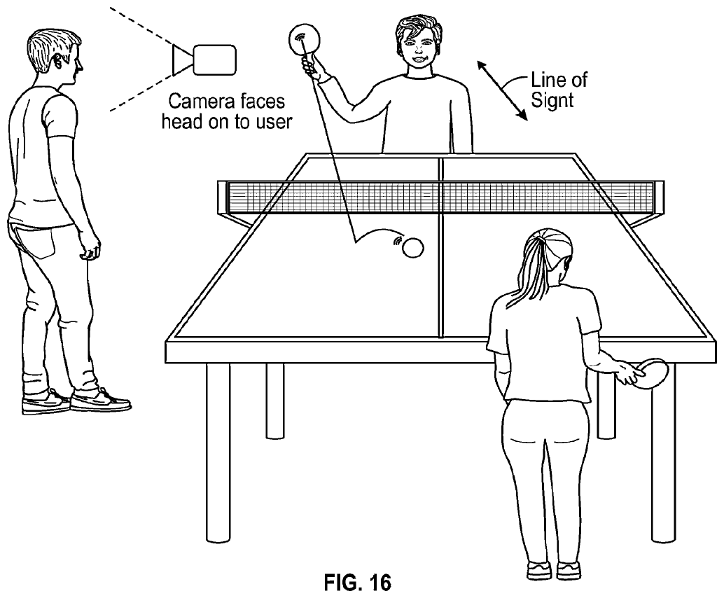

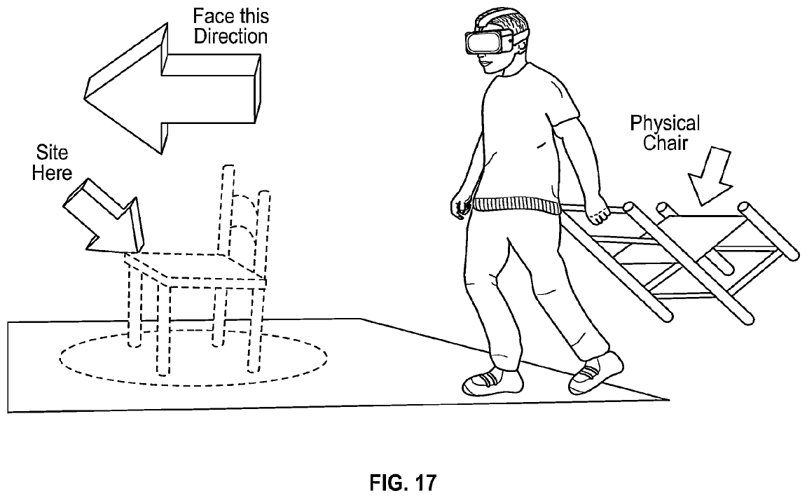

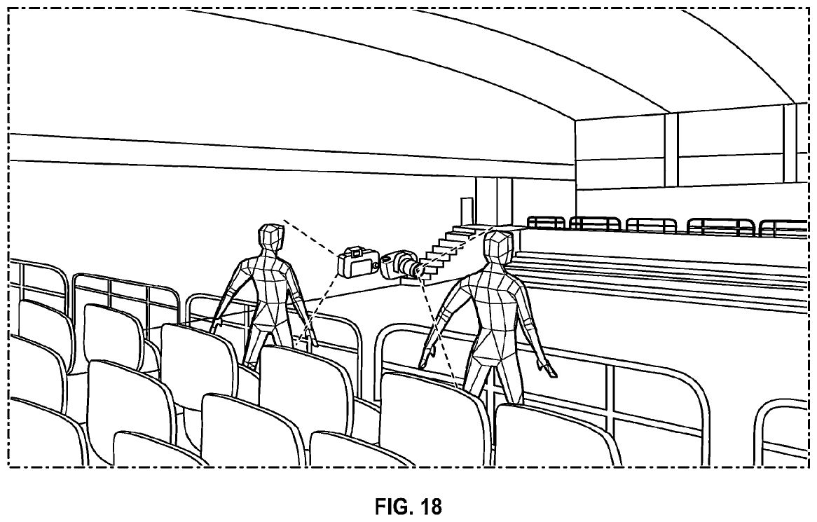

Next, FIG. 13, FIG. 14, FIG. 15, FIG. 16, FIG. 17, and FIG. 18 illustrate various scenarios for user interaction in the immersive calling system as described herein.

FIG. 13A illustrates an exemplary set up of a room scale boundary in a setting of a skybox in a VR environment. In this example, the chairs for User A and B are facing the same direction; FIG. 13B illustrates an exemplary set up of a room scale boundary in a setting of a park in a virtual environment. In this example, the chairs for User A and B are facing each other and the cameras are placed opposite of one another.

FIG. 13C shows another example of setting up VR boundaries. In this example, User A and User B stationary boundaries and their corresponding room scale boundaries are illustrated.

FIG. 13D illustrates another exemplary set up of a room scale boundary in a setting of a beach in a VR environment. In this example, the chairs for User A and B are facing the same direction; FIG. 13E illustrates an exemplary set up of a room scale boundary in a setting of a train in a VR environment. In this example, the chairs for User A and B are facing each other where the cameras are placed opposite of one another.

FIGS. 14 and 15 illustrate various embodiments VR setups where side profiles for user are captured by capture devices.

FIG. 16 illustrates an example of performing an immersive VR activity (e.g., playing table tennis) such that a first user is facing another user where the cameras are positioned head-on to capture the front views of the users. Accordingly, the users' line of sight can be fixed on the other user in the VR environment. FIG. 18 illustrates an example of two users standing at a sports venue where the side profile of each user is captured by their capture device.

In order to capture proper user images, users are prompted to move to a proper position and orientation. FIG. 17 illustrates an example that a user wears a HMD and the HMD provides instructions to a user to move a physical chair to a designated location and facing direction such that proper images of the user can be captured.

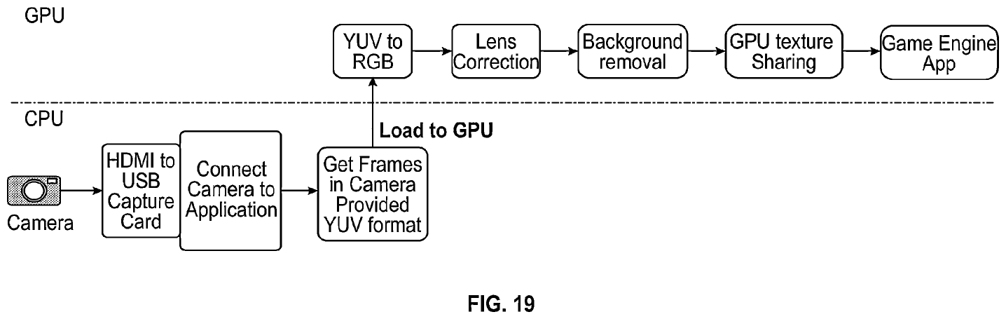

The following describes an embodiment for capturing images from a camera, which apply arbitrary code to transform the image on a GPU, and then send the transformed images to be displayed in a game engine without leaving the GPU. An example is described in more details in connection with FIG. 19.

This capture method includes the following advantages: a single copy function from CPU memory to GPU memory; all operations performed on a GPU, where the highly parallelizable ability of the GPU enables processing images much faster than if performed using a CPU; sharing the texture to a game engine without leaving the GPU enables a more efficient way of sending data to a game engine; and reducing the time between image capture and display in a game engine application.

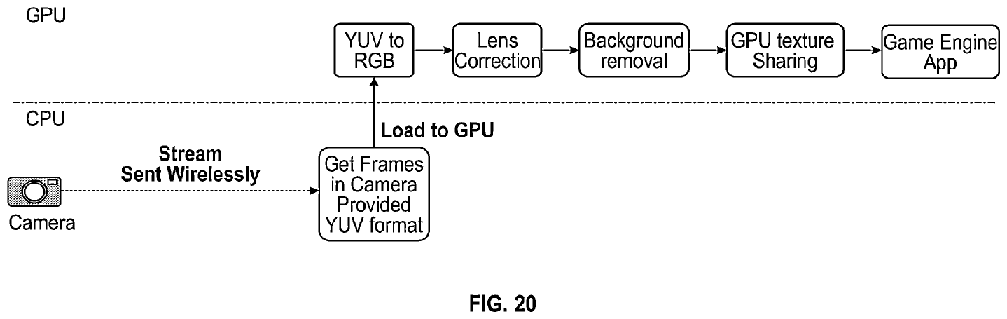

In the example illustrated in FIG. 19, upon connecting the camera to application, the camera transfers frames of a video stream captured by a camera into an application to facilitate displaying the frames via a game engine. In this example, video data is transferred to the application via an audio/video interface such as HDMI to USB capture card which enables obtaining uncompressed video frames with very low latency at a high resolution. In another embodiment, as shown in FIG. 20, a camera wirelessly transmits a video stream to a computer, where the video stream is decoded.

Next, the system gets frames in camera provided in native format. In this step, the system obtain frames in native format provided by the camera. In the present embodiment, for description purposes only, the native format is the YUV format. Use of the YUV format is not seen to be limiting and any native format that would enable practice of the present embodiment is applicable.

Subsequently, data is loaded to GPU where a YUV encoded frame is loaded into a GPU memory to enable highly parallelized operations to be performed on the YUV encoded frame. Once an image is loaded onto the GPU, the image is converted from YUV format to RGB to enable additional downstream processing. Mapping function(s) are then applied to remove any image distortions created by the camera lens. Thereafter, deep learning methods are employed to isolate a subject from their background in order to remove the subject's background. To send an image to a game engine, GPU texture sharing is used to enable writing the texture into a memory where the game engine reads it. This process prevents data from being copied from the CPU to the GPU. A game engine is used to receive the texture from the GPU and display it to users on various devices. Any game engine that would enable practice of the present embodiment is applicable.

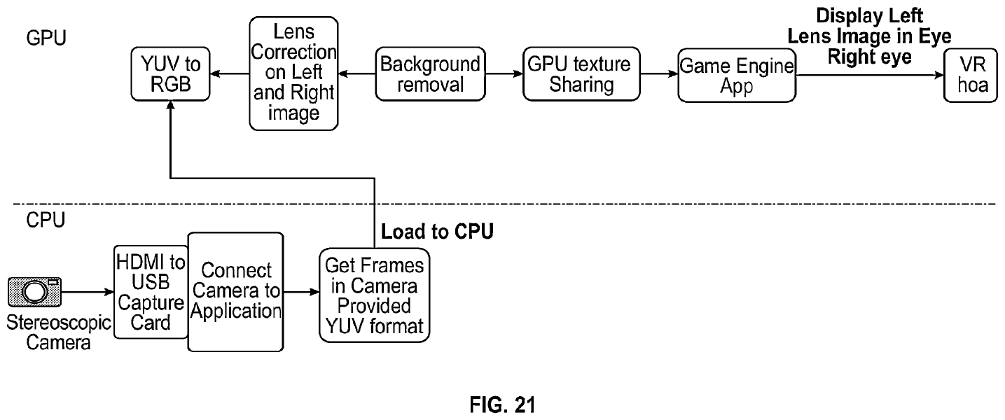

In another embodiment, as illustrated in FIG. 21, a stereoscopic camera is used, where lens correction is performed on each image half. A stereoscopic camera provides a user with a 3D effect of the image by displaying the captured image from the left lens only for the left eye and displaying the captured image from the right lens only for the right eye. This can be achieved via the use of VR headset. Any VR headset that would enable practice of the present embodiment is applicable.

Relighting of an object or environment could be very important in augmented VR. Generally, the images of a virtual environment and the images of different users are taken in different places at different time. These differences in places and time will make it impossible to maintain an exactly same lighting condition among users and the environment.

The difference in lighting condition will cause a different appearance in the images taken from the objects. Humans are able to utilize this difference in appearance to extract the lighting condition for the environment. If different objects are taken at different lighting conditions and are just directly combined together into the VR without any processing, a user will be aware of some inconsistence in the lighting conditions extracted from different objects, causing a non-natural perception of the VR environment.

In addition to the lighting condition, the cameras used for image capture for different users as well as the virtual environment are also often different. Each camera has its own non-linear hardware-dependent color-correction functionality. Different cameras will have different color-correction functionalities. This difference in color-correction will also make a perception of different lighting appearances for different objects even they are in the same lighting environment.

Given all these lighting and camera differences or variations, it is critical in augmented VR to relight the raw capture image of different objects to make them be consistent to each other in the lighting information that the objects deliver.

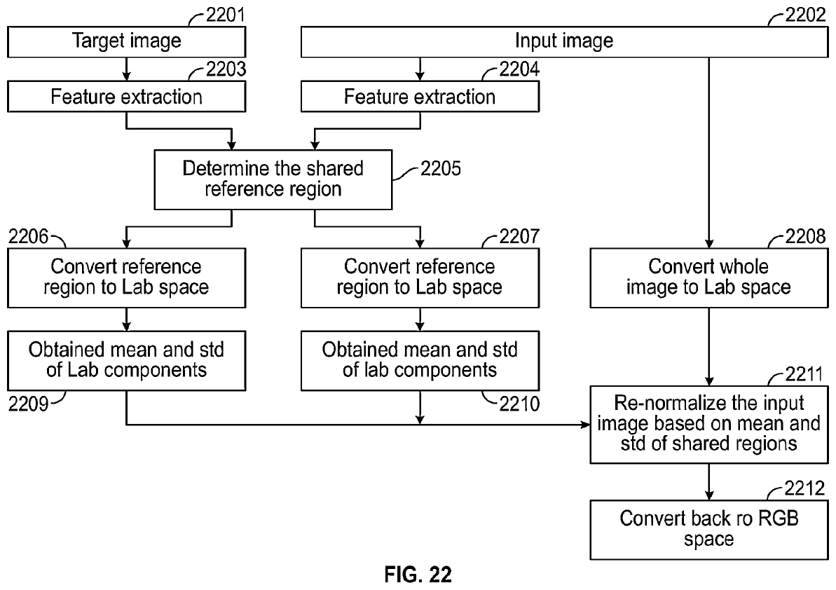

FIG. 22 shows a workflow diagram to implement a region-based object relighting method using Lab color space according to an exemplary embodiment. Lab color space is provided as an example, and any color space that would enable practice of the present embodiment is applicable.

Given the input 2201 and target 2202 images, first, a feature extraction algorithm 2203 and 2204 is applied to locate the feature points for a target image and an input image. Then, in step 2205, a shared reference region is determined based on the feature extraction. After that, the shared regions are converted in both the input and target images from RGB color space to Lab color space (e.g., CIE Lab color space) in steps 2206 and 2207 and 2208, respectively. The Lab information obtained from shared regions will be used to determine a transform matrix in steps 2209 and 2210. This transform matrix will then be applied to the entire or some specific regions of input image to adjust its Lab components in step 2211 and output the final relighting of input image after being converted back to RGB color space in step 2212.

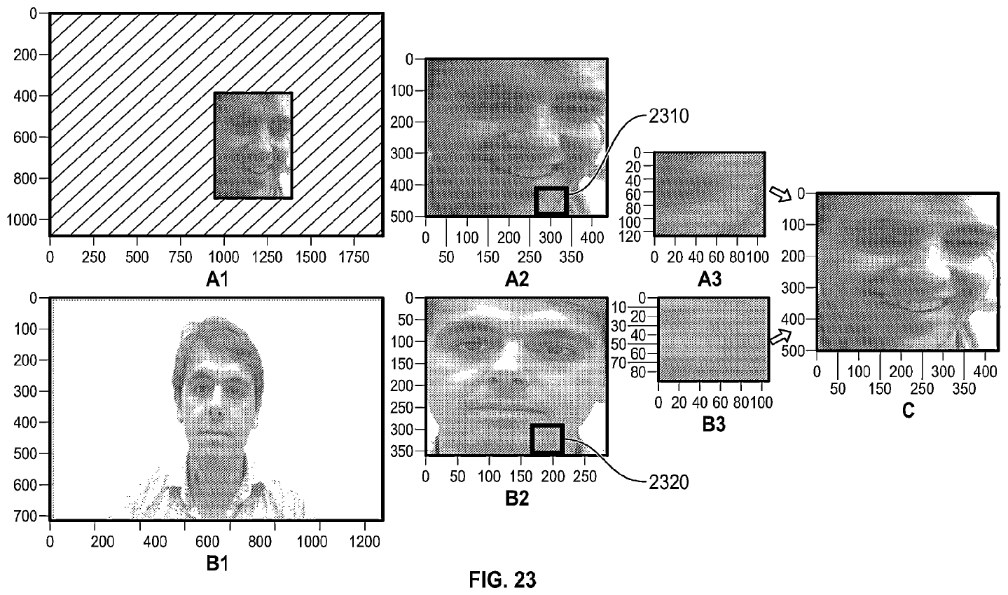

An example is shown in connection with FIG. 23 to explain the details of each step.

FIG. 23 shows a workflow of the process of the present embodiment to relight an input image based on the lighting and color information from a target image. The input image is shown in A1, and the target image is shown in B1. An object of the present invention is to make the lighting of the face in the input image to be closer to the lighting of the target image. First, the face is extracted using a face-detection application. Any face detection application that would enable practice of the present embodiment is applicable.

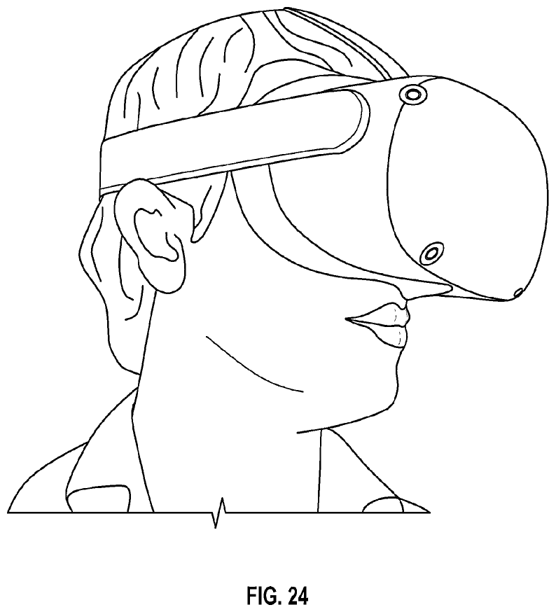

In the present example, the entire face from two images was not used as the reference for relighting. The entire face was not used since in a VR environment, users typically wear a head mounted display (HMD) as illustrated in FIG. 24. As FIG. 24 illustrates, when a user wears an HMD, the HMD typically blocks the entire top half of the user's face, leaving only the bottom half of the user's face visible to a camera. Another reason the entire face was not used is that even if a user does not wear an HMD, the content of two faces could also be different. For example, the face in FIGS. 23 (A1) and 23 (A2) has an open mouth, while the face in FIGS. 23 (B1) and 23 (B2) has a closed mouth. The difference in mouth region between these images could result in an incorrect adjustment for the input image should the entire face be used should the entire face area be used. Not using the entire face also provides flexibility with respect to relighting of an object. A region-based method enables different controls to be provided for different areas of an object.

As shown in FIGS. 23 A2 and B2, a common region from the lower-right area of the face is selected, which are shown as rectangles in A2 (2310) and B2 (2320) and replotted as A3 and B3. The selected region served as the reference area used for relighting of input image. However, any region of an image that would enable practice of the present embodiment can be selected.

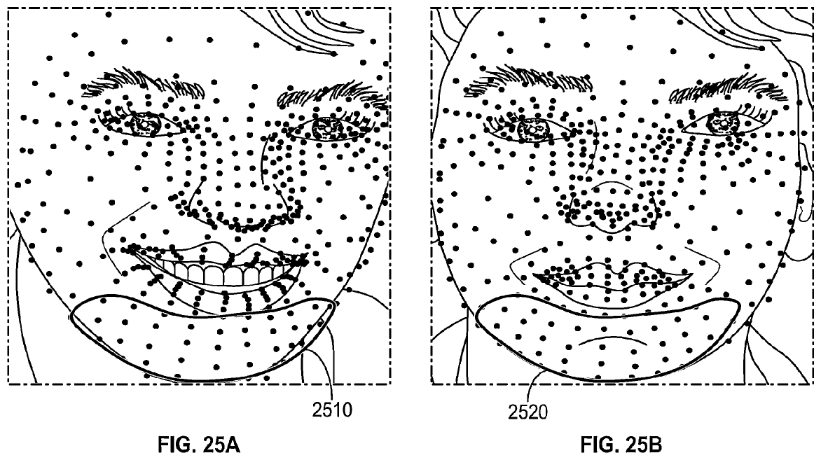

While the above description discussed a manual selection of a specific region for the input image and the target image, in another exemplary embodiment, the selection can be automatically determined based on the feature point detected from a face. One example is shown in FIG. 25A and FIG. 25B. Application of a face feature identifier application results in locating 468 face feature points for both images. Any face feature identifier application that would enable practice of the present embodiment is applicable. These feature points serve as a guideline to selecting shared region for relighting. Any face area can then be chosen. For example, the entire lower face area can be selected as a shared region, which is illustrated via the boundary in A and B.

After a shared region is obtained, relighting the face in the input image occurs. The first step of this process is to convert the existing RGB color space. While there are many color spaces available to represent color, RGB color space is the most typical one. However, RGB color space is device-dependent, and different devices will produce color differently.

Thus it is not ideal to serve as the framework for color and lighting adjustment, and conversion to a device-independent color space provides a better result.

As described above, in the present embodiment, CIELAB, or Lab color space is used. It is device-independent, and computed from an XYZ color space by normalizing to a white point. “CIELAB color space use three values, L*, a* and b*, to represent any color. L* shows the perceptual lightness, and a* and b* can represent four unique colors of human vision” (https://en.wikipedia.org/wiki/CIELAB_color_space).

Lab component from RGB color space can be obtained, for example, according to Open Source Computer Vision color conversions. After the Lab components for the shared reference region in both the input and target images, their means and standard deviations are calculated. Some embodiments use other measures of centrality and variation other than mean and standard deviation. For example, median and median absolute deviation may be used to robustly estimate these measures. Of course other measures are possible and this description is not meant to be limited to just these. Then the following equation is executed to adjust the Lab components of all or some specific selected regions of the input image.

$${x}_{input} = \frac{{x}_{input} - mean ( {x}_{input} )}{std ( {x}_{input} )} std ( {x}_{target} ) + mean ( {x}_{target} )$$

here x is any one of three components, L\hat{ }*,a\hat{ }*,b\hat{ }*, in CIELAB space.

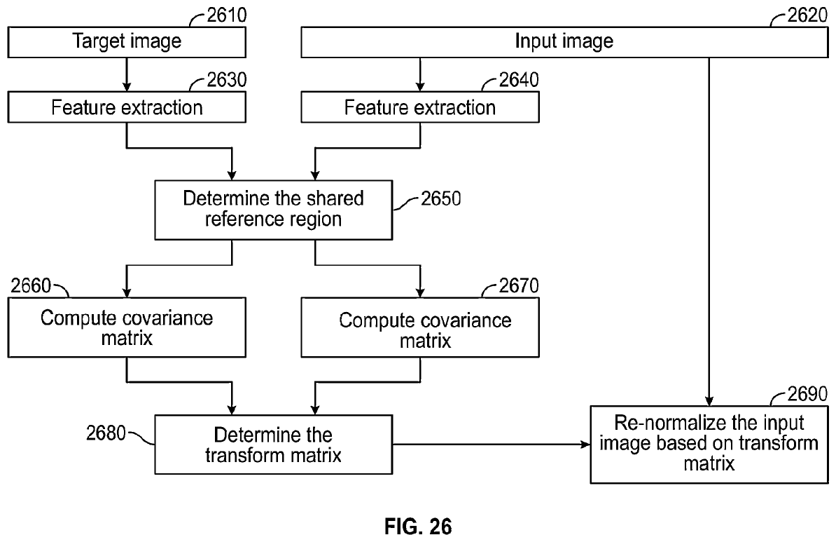

In another exemplary embodiment, which is more data driven-based, a covariance matrix of RGB channel is used. Whitening the covariance matrix enables decoupling the RGB channel, similar to what is done using Lab color space such as CIELab color space. The detailed steps are shown in FIG. 26.

In FIG. 26, a feature extraction algorithm (2630 and 2640) is used to locate the key feature points in both the input and target images. Then, a shared reference region is determined based on the key point locations in both images. FIG. 26 differs from FIG. 22 in that the RGB channel is not converted into lab color space. Instead, the covariance matrix of both the input and target images shared regions are calculated directly from the RGB channel. Then, a single value decomposition (SVD) is applied to obtain the transform matrix from these two covariance matrix. The transform matrix is applied to the entire input image to obtain its corresponding relighting matrix which is used and applied to correct the image that will ultimately be displayed to the user.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

1. A method for relighting captured images in a virtual reality environment, the method comprising:
acquiring an input image;
acquiring a target image;
determining at least one shared reference region for the acquired input image and at least one shared reference region for the acquired target image;
determining a transform matrix based on the color space of the shared region;
applying the transform matrix to at least a portion of the acquired input image;
outputting the transformed portion of the acquired input image; and
displaying the outputted transformed portion of the acquired input image.

2. The method according to claim 1, wherein the determination of at least one shared reference region for the acquired input image and at least one shared reference region for the acquired target image is based on respective extracted feature points on acquired input image and acquired target image.

3. The method according to claim 1, further comprising
converting the device dependent color space data on at least one shared reference region for the acquired input image and the at least one shared reference region for the acquired target image to device independent color space data.

4. The method according to claim 3, further comprising
converting the transformed portion of the acquired input image from device independent color space data back to device dependent color space data.

5. The method according to claim 1, wherein selection of the input image and selection of the target image to be acquired is performed via a manual operation.

6. The method according to claim 1, further comprising
automatically determining the selection of the input image and selection of the target image to be acquired based on a feature point detection operation.

7. The method according to claim 6, further comprising
determining the shared regions by extracting at least one feature point for the acquired input image and at least one feature point for the acquired target image.

8. An information processing apparatus configured to perform relighting of captured images in a virtual reality environment comprising:
one or more memories storing instructions; and
one or more processors that, upon execution of the stored instructions, are configured to
acquire an input image;
acquire a target image;
determine at least one shared reference region for the acquired input image and at least one shared reference region for the acquired target image;
determine a transform matrix based on the color space of the shared region;
applying the transform matrix to at least a portion of the acquired input image;
output the transformed portion of the acquired input image; and
display the outputted transformed portion of the acquired input image.

9. The information processing apparatus according to claim 8, wherein the determination of at least one shared reference region for the acquired input image and at least one shared reference region for the acquired target image is based on respective extracted feature points on acquired input image and acquired target image.

10. The information processing apparatus according to claim 8, wherein execution of the instructions further configures the one or more processors to
convert the device dependent color space data on at least one shared reference region for the acquired input image and the at least one shared reference region for the acquired target image to device independent color space data.

11. The information processing apparatus according to claim 10, wherein execution of the instructions further configures the one or more processors to
convert the transformed portion of the acquired input image from device independent color space data back to device dependent color space data.

12. The information processing apparatus according to claim 8, wherein selection of the input image and selection of the target image to be acquired is performed via a manual operation.

13. The information processing apparatus according to claim 8, wherein execution of the instructions further configures the one or more processors to
automatically determine the selection of the input image and selection of the target image to be acquired based on a feature point detection operation.

14. The information processing apparatus according to claim 13, wherein execution of the instructions further configures the one or more processors to
determine the shared regions by extracting at least one feature point for the acquired input image and at least one feature point for the acquired target image.

15. (canceled)

16. A method for relighting captured images in a virtual reality environment, the method comprising:
acquiring an input image;
acquiring a target image;
determining at least one shared reference region for the acquired input image and at least one shared reference region for the acquired target image;
calculating a covariance matrix of the at least one shared reference region for the acquired input image and the at least one shared reference region for the acquired target image from device dependent color space data associated with the respective at least one shared reference regions;
determining a transform matrix based on the calculated covariance matrices;
applying the transform matrix to at least a portion of the acquired input image;
outputting the transformed portion of the acquired input image; and
displaying the outputted transformed portion of the acquired input image.

17. The method according to claim 16, further comprising
determining at least one shared reference region for the acquired input image and at least one shared reference region for the acquired target image based on respective extracted feature points on acquired input image and acquired target image.

18. The method according to claim 16, further comprising
determining at least one shared reference region for the acquired input image and at least one shared reference region for the acquired target image based on respective extracted feature points on acquired input image and acquired target image.

19. The method according to claim 16 further comprising:
converting the device dependent color space data on at least one shared reference region for the acquired input image and the at least one shared reference region for the acquired target image may to device independent color space data.

20. The method according to claim 19, further comprising
converting the transformed portion of the acquired input image from device independent color space data may be converted back to device dependent color space data.

21. An information processing apparatus configured to perform relighting of captured images in a virtual reality environment comprising:
one or more memories storing instructions; and
one or more processors that, upon execution of the stored instructions, are configured to
acquire an input image;
acquire a target image;
determine at least one shared reference region for the acquired input image and at least one shared reference region for the acquired target image;
calculate a covariance matrix of the at least one shared reference region for the acquired input image and the at least one shared reference region for the acquired target image from device dependent color space data associated with the respective at least one shared reference regions;
determine a transform matrix based on the calculated covariance matrices;
apply the transform matrix to at least a portion of the acquired input image;
output the transformed portion of the acquired input image; and
displaying the outputted transformed portion of the acquired input image.

22. The information processing apparatus according to claim 21, wherein execution of the instructions further configures the one or more processors to
determine at least one shared reference region for the acquired input image and at least one shared reference region for the acquired target image based on respective extracted feature points on acquired input image and acquired target image.

23. The information processing apparatus according to claim 21, wherein execution of the instructions further configures the one or more processors to
determine at least one shared reference region for the acquired input image and at least one shared reference region for the acquired target image based on respective extracted feature points on acquired input image and acquired target image.

24. The information processing apparatus according to claim 21, wherein execution of the instructions further configures the one or more processors to
convert the device dependent color space data on at least one shared reference region for the acquired input image and the at least one shared reference region for the acquired target image may to device independent color space data.

25. The information processing apparatus according to claim 24, wherein execution of the instructions further configures the one or more processors to
convert the transformed portion of the acquired input image from device independent color space data may be converted back to device dependent color space data.

26. (canceled)
